(19) United States
(12) Patent Application Publication
(10) Pub. No.: US 2010/0040917 A1
(43) Pub. Date: Feb. 18, 2010

(54) FUEL CELL SYSTEM AND METHOD OF STARTING A FUEL CELL SYSTEM

(75) Inventors: Stefan Kading, Zerrenthin (DE); Norbert Gunther, Rabnitz Damgarten (DE); Henry Rosin, Neurbrandeburg (DE)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,217

(22) PCT Filed: Aug. 1, 2007
(86) PCT No.: PCT/DE07/01366

§ 371 Date: Mar. 5, 2009

(30) Foreign Application Priority Data
Sep. 15, 2006 (DE) 10 2006 043 349.1

(51) Int. Cl. H01M 8/04

(52) U.S. Cl. 429/17; 429/19

(57) ABSTRACT

The invention relates to a method of starting up a fuel cell system comprising a reformer (10) and a fuel cell stack (12), the reformer receiving during a first start-up phase a supply of oxygen and fuel with a first air ratio λᵢ characterizing the fuel/air ratio, the reformer receiving during a second start-up phase a supply of oxygen and fuel with a second air ratio λ₂ characterizing the fuel/air ratio, the first fuel/air ratio λ₁ being larger than the second air ratio λ₂ (λ₁>λ₂) and the fuel cell stack receiving a supply of reformate (18) generated in the reformer during the first and the second start-up phase.

In accordance with the invention it is provided for that the transition from the first start-up phase to the second start-up phase is monitored by sensing a voltage furnished by the fuel cell stack (12).

The invention relates furthermore to a fuel cell system.

The invention relates to a method of starting up a fuel cell system comprising a reformer and a fuel cell stack, the reformer receiving during a first start-up phase a supply of oxygen and fuel with a first air ratio λ₁ characterizing the fuel/air ratio, the reformer receiving during a second start-up phase a supply of oxygen and fuel with a second air ratio λ₂ characterizing the fuel/air ratio, the first air ratio λ₁ being larger than the second air ratio λ₂ (λ₁>λ₂) and the fuel cell stack receiving a supply of reformate (18) generated in the reformer during the first and the second start-up phase.

The invention relates furthermore to a fuel cell system comprising a reformer and a fuel cell stack, the reformer receiving during a first start-up phase a supply of oxygen and fuel with a first air ratio λ₁ characterizing the fuel/air ratio, the reformer receiving during a second start-up phase a supply of oxygen and fuel with a second air ratio λ₂ characterizing the fuel/air ratio, the first air ratio λ₁ being larger than the second air ratio λ₂ (λ₁>λ₂) and the fuel cell stack receiving a supply of reformate (18) generated in the reformer during the first and the second start-up phase.

In generic fuel cell systems electricity is generated in a fuel cell stack. For this purpose the fuel cell stack receives a supply of air and a hydrogen rich reformate, the latter being generated in a reformer from fuel and an oxidant, particularly air. To optimize the H2 yield the reformers work with air ratios, characterizing the fuel/air ratio, of 0.4 or lower.

Solid oxide fuel cell (SOFC) systems have operating temperatures exceeding 800° C. which need to be attained in one start-up phase. The thermal energy needed for this purpose is furnished by the hot gases streaming from the reformer as well as by preheated cathode feed air to the fuel cell stack. The reformer makes a high heat yield available when it is operated as a burner, i.e. particularly with an air ratio λ characterizing the fuel/air ratio which is above 1 (λ>1). Once a certain temperature is attained so that as regards generating electricity a system exists capable of functioning as such in principle, the reformer is changed over to the reforming mode, i.e. with an air ratio below 1, for instance 0.4 or lower. Changing the air ratio can be done, for example, by feeding additional fuel via a secondary fuel feeder. One such system featuring a secondary fuel feeder is disclosed, for example, in German patent DE 103 59 205 A1.

Monitoring start-up of the fuel cell system is possible by sensing the temperature in the afterburner which increases when a high concentration of oxidizable gases flows into the afterburner, this being, naturally, more often the case during reforming than in the burner mode. Monitoring, however, is hampered by time delays caused particularly by the flow paths of the gases through the system and the ignition velocity in the afterburner.

The invention is based on the object of providing a method of starting up a fuel cell system and one such fuel cell system, so that the transition between the start-up phases of a fuel cell system is reliably achieved practically with zero delay.

This object is achieved by the features of the independent claims.

Advantageous embodiments of the invention read from the dependent claims.

The invention is a sophistication over the generic method in that the transition from the first start-up phase to the second start-up phase is monitored by sensing a voltage furnished by the fuel cell stack. The voltage furnished by the fuel cell stack mainly depends on whether the reformer is working like a burner or whether the reforming mode has already been successfully initiated. Once a diminished air ratio is made available as is characteristic for the reforming mode there is a sudden increase in the cell voltage. When this increase is sensed, then the transition to the second start-up phase in which reforming already occurs was successful, otherwise the transition failed to occur. As the voltage for monitoring the start-up phase the voltage furnished by the fuel cell stack as a whole can be used. As an alternative the voltage of a single cell or the voltages furnished by certain groups of fuel cell system can serve monitoring.

It is expediently provided for that the transition from the first start-up phase to the second start-up phase is prompted as a function of a temperature. At system temperatures exceeding 300° C. a SOFC fuel cell stack can furnish a voltage which is dictated by the air ratio of the mixture supplied to the reformer. It is thus expedient to restrict monitoring start-up as a function of the voltage to temperatures above, for example, 300° C. which is expedient in any case since below this temperature further operation as a burner is of advantage.

The invention is sophisticated particularly to advantage in that a satisfactory transition from the first to the second start-up phase is recognized when the voltage furnished by the fuel cell stack exceeds a predefined voltage value. The absolute value of the voltage furnished by the fuel cell stack can thus serve as the criterion for monitoring in accordance with the invention.

As an alternative, or in addition thereto, it may be provided for that a satisfactory transition from the first to the second start-up phase is recognized when the voltage furnished by the fuel cell stack increases by a predefined voltage value. The difference between the voltage furnished by the fuel cell stack during the first start-up phase and during the second start-up phase can thus serve as the parameter characterizing monitoring.

It may be provided for that the predefined voltage value is established on the basis of values as obtained empirically.

As an alternative, or in addition thereto, it may be provided for that the predefined voltage value is established on the basis of values as obtained in theory. In accordance with the Nernst equation

$${U}_{eq} = \frac{RT}{zF} ln \frac{{ϕ}_{{O}_{2}}}{0 \text{,} 206}$$

the cell voltage U_{eq} is a function of the oxygen concentration φ_{O}_{₂} (where R is the universal gas constant; T the absolute temperature; z the equivalent number; F the Faraday Constant; φ_{O}_{₂} the oxygen proportion). Thus by making use of this theoretical formula successful initiation of reforming can be monitored.

The invention is a sophistication over the generic fuel cell system in that the transition from the first start-up phase to the second start-up phase is monitored by sensing a voltage furnished by the fuel cell stack in thus achieving the advantages and special features of the method in accordance with the invention also in the scope of a fuel cell system. This applies as well to the particularly preferred embodiments of the fuel cell system in accordance with the invention as recited in the following.

The system is sophisticated particularly to advantage in that the fuel cell system comprises an electronic controller for monitoring start-up. Such an electronic controller preferably features a memory and serves either to control solely the fuel cell system or it handles control functions of components outside of the fuel cell system, for example, in a vehicle. It is just as possible that the electronic controller is integrated in some other controller of a vehicle, for instance in a so-called on-board computer.

The invention will now be detailed by way of particularly preferred embodiments with reference to the attached drawings in which:

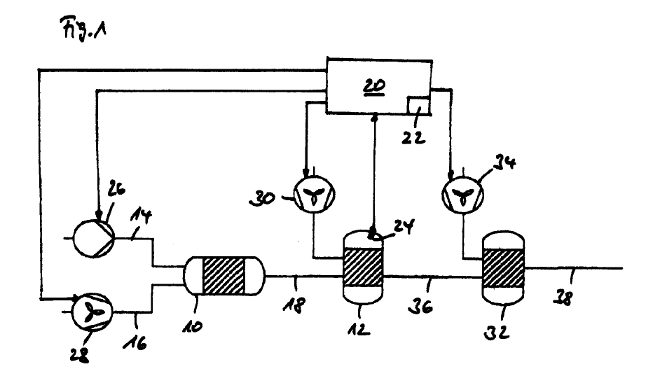

FIG. 1 is a diagrammatic representation of a fuel cell system;

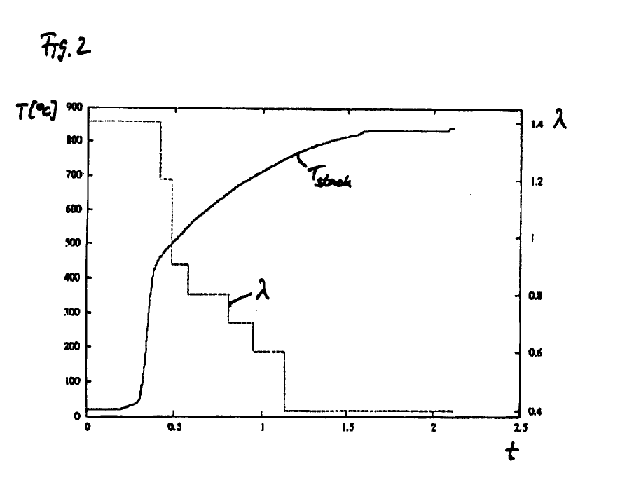

FIG. 2 is a graph showing a temperature/time plot and an air ratio/time plot as a function thereof in accordance with the invention;

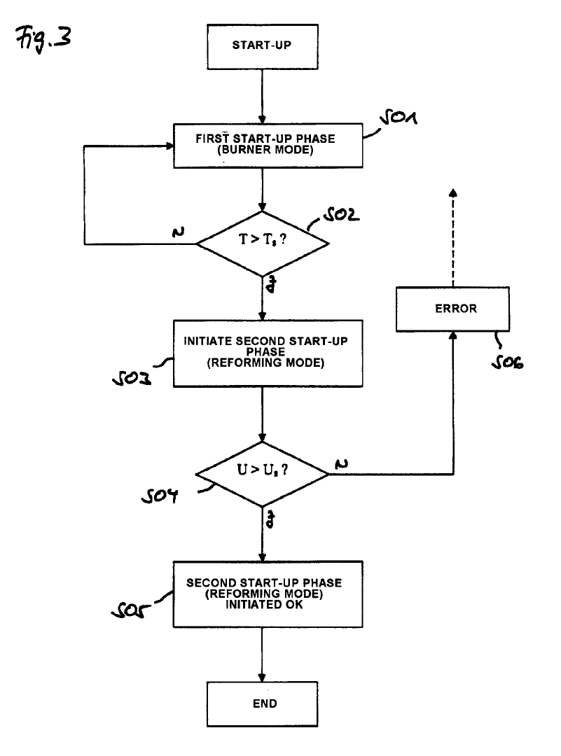

FIG. 3 is a flow chart showing a temperature/air ratio plot to assist in explaining the present invention.

Referring now to FIG. 1 there is illustrated a diagrammatic representation of a fuel cell system. The fuel cell system comprises a fuel feeder 26, i.e. particularly a fuel pump, and an air feeder 28, i.e. particularly a blower, both coupled to the input of a reformer 10. At the output end the reformer 10 is coupled to the anode end of a fuel cell stack 12, the cathode end of which is connected to an air feeder 30, i.e. particularly a blower. The fuel cell stack 12 features a temperature sensor 24. At its output end the fuel cell stack 12 is connected to an afterburner 32 which is likewise connected to an air feeder 34, i.e. particularly a blower. Also provided is an electronic controller 20 including a memory 22 connected to the sensors of the system, i.e. particularly the temperature sensor 24 of the fuel cell stack 12 for receiving the signals. The controller 20 is furthermore in connection with the fuel feeder 26 as well as with the air feeders 28, 30, 34 to tweak their operation and in the scope of closed loop control, respectively. The controller is suitable for capturing the voltage of individual cells and/or the overall voltage of the fuel cell stack 12.

In operation of the system the fuel pump 26 and the blower 28 feed fuel 14 and air 16 respectively to the reformer 10. In the reformer a hydrogen rich reformate 18 materializes which is fed to the anode end of the fuel cell stack 12. The cathode end of the fuel cell stack 12 receives a supply of cathode feed air via the blower 30. This cathode feed air is expediently preheated. The reformate 36 depleted in the fuel cell stack 12 is fed to an afterburner 32 which likewise receives a supply of air from the blower 34 for implementing combustion preferably free of residuals. The output of the afterburner 32 is exhaust gas 38, the thermal energy of which can be returned to the heat balance of the fuel cell system, for example, to preheat the cathode feed air forwarded by the blower 30.

On start-up of the fuel cell system it is provided for that the air ratio λ, with which the reformer 10 is operated, can be set as a function of the temperature of the fuel cell stack 12 as sensed by the temperature sensor 24 by the electronic controller 20 tweaking the fuel feeder 26 and/or the blower 28. The setting is made so that uncritical air ratio/temperature combinations materialize particularly as regards sooting up of the fuel cell stack 12 and oxidation of the anode material in the fuel cell stack 12, since in a combination of low temperatures and low air ratios sooting up becomes excessive whilst oxidation of the fuel cell anode becomes a problem in a combination of high temperatures and high air ratios.

Referring now to FIG. 2 there is illustrated a graph showing a temperature/time plot and an air ratio/time plot as a function thereof in accordance with the invention. Illustrated is an exemplary temperature curve of the fuel cell stack plotted as a function of time. The temperature T_{Stack} is based on a starting temperature value, for example, room temperature, and then quickly increasing to temperatures in the region of 500° C. before then approaching the operating temperature of the fuel cell stack of approx. 850° C. It is as a function of this that the air ratio λ of the reformer can be set, namely on the basis of λ=1.4 before then decreasing down to a value of λ=0.4. It is not necessary that λ is varied, as shown, incrementally, a continual curve of the air ratio being just as practical. The air ratio values λ to be set for specific temperatures T_{stack} are expediently saved in a controller in the form of a Table. In addition to the sensed temperature T_{stack} a temperature T_{stack} as established empirically as a function of time can be saved in a memory of a controller.

In accordance with the invention it is provided for that a changeover from the burner mode to the reforming mode, in other words from the first start-up phase to the second start-up phase is done at 300° C. This changeover can be done by causing a sudden drop in the air ratio or, as shown in FIG. 2, by diminishing the air ratio incrementally or continuously. When the controller “sees” a corresponding step in the voltage furnished by the fuel cell stack, satisfactory initiation of the second start-up phase and thus ultimately also of the reforming process is assured, whereas absence of such a step in the voltage indicates no success in the transition into the reforming process.

Referring now to FIG. 3 there is illustrated a flow chart to assist in explaining the present invention. After start-up of the system the reformer is operated in a first start-up phase as a burner (step S01). During this first start-up phase a check is made in step S02 as to whether the temperature of the system, for example the temperature of the fuel cell stack, exceeds a threshold temperature T_{S}. If not, the first start-up phase is continued in accordance with step S01. But if the threshold temperature TS is exceeded the fuel cell system is switched to the second start-up phase (step S03). Whether this was successful is checked in step S04, by the cell voltage U being compared to a threshold voltage U_{S}. When the cell voltage exceeds the threshold voltage U_{S} this is an indication that the second start-up phase, i.e. the reforming mode, was successfully initiated (step S05). But if the voltage sensed in step S04 fails to exceed the threshold voltage U_{S} this is an indication of initiation of the second start-up phase, i.e. the reforming mode in step S06, not having been successful. Responding to this fault may be done in several ways, for instance, by shutting down the system, restarting the system, display of an error message, or the like.

It is understood that the features of the invention as disclosed in the above description, in the drawings and as claimed may be essential to achieving the invention both by themselves or in any combination.

### LIST OF REFERENCE NUMERALS

10 reformer

12 fuel cell stack

14 fuel

16 air

18 reformate

20 controller

22 memory

24 temperature sensor

26 fuel feeder

28 blower

30 blower

32 afterburner

34 blower

36 reformate

38 exhaust gas

1. A method of starting up a fuel cell system comprising a reformer and a fuel cell stack comprising the steps of,
the reformer receiving during a first start-up phase a supply of oxygen and fuel with a first air ratio λ₁ characterizing the fuel/air ratio,
the reformer receiving during a second start-up phase a supply of oxygen and fuel with a second air ratio λ₂ characterizing the fuel/air ratio, the first fuel/air ratio λ₁ being larger than the second air ratio λ₂ (λ₁>λ₂), and
the fuel cell stack receiving a supply of reformate generated in the reformer during the first and the second start-up phase,
wherein the transition from the first start-up phase to the second start-up phase is monitored by sensing a voltage furnished by the fuel cell stack.

2. The method of starting up a fuel cell system of claim 1, wherein the transition from the first start-up phase to the second start-up phase is prompted as a function of a temperature.

3. The method of starting up a fuel cell system of claim 1 wherein a satisfactory transition from the first to the second start-up phase is recognized when the voltage furnished by the fuel cell stack exceeds a predefined voltage value.

4. The method of starting up a fuel cell system of claim 1 wherein t a satisfactory transition from the first to the second start-up phase is recognized when the voltage furnished by the fuel cell stack increases by a predefined voltage value.

5. The method of starting up a fuel cell system of claim 3 wherein the predefined voltage value is established on the basis of values as obtained empirically.

6. The method of starting up a fuel cell system of claim 3 wherein the predefined voltage value is established on the basis of a fuel cell voltage as obtained in theory.

7. The method of starting up a fuel cell system of claim 6, wherein the predefined voltage value is established in theory with inclusion of the actual air ratio.

8. A fuel cell system comprising:
a reformer and a fuel cell stack,
the reformer receiving during a first start-up phase a supply of oxygen and fuel with a first air ratio λ₁ characterizing the fuel/air ratio,
the reformer receiving during a second start-up phase a supply of oxygen and fuel with a second air ratio λ₂ characterizing the fuel/air ratio,
the first fuel/air ratio λ₁ being larger than the second air ratio λ₂ (λ₁>λ₂) and
the fuel cell stack receiving a supply of reformate generated in the reformer during the first and the second start-up phase,
wherein the transition from the first start-up phase to the second start-up phase can be monitored by sensing a voltage furnished by the fuel cell stack.

9. The fuel cell system of claim 8, wherein the fuel cell system comprises an electronic controller for monitoring system start-up.
